(19) United States
(12) Patent Application Publication
(10) Pub. No.: US 2006/0017536 A1
(43) Pub. Date: Jan. 26, 2006

(54) Systems, methods and apparatus for hybrid shielding in a magnetic resonance imaging system

(75) Inventor: Bu-Xin Xu, Florence, SC (US)

Correspondence Address: JAMES D IVEY, 3025 TOTTERDELL STREET, OAKLAND, CA, 94611-1742, US

(73) Assignee: General Electric Company, Schenectady, NY (US)

(21) Appl. No.: 10/899,831

(22) Filed: Jul. 26, 2004

(51) Int. Cl. H01F 3/00

(52) U.S. Cl. 335/296

(57) ABSTRACT

Systems, methods and apparatus are provided through which in some embodiments, a magnetic resonance imaging system includes a ferromagnetic shield positioned between main coils and bucking coils. The ferromagnetic shield reduces magnetic coupling between the main coils and the bucking coils, which provides for the main coils and bucking coils having a reduced size and cost.

### FIELD OF THE INVENTION

This invention relates generally to magnetic resonance imaging systems, and more particularly to shielding in magnetic resonance imaging systems.

### BACKGROUND OF THE INVENTION

Conventional magnetic resonance imaging (MRI) systems with a passive shielded magnet have iron shielding around a cryostat, such as a helium vessel. The helium vessel contains superconducting magnets. The iron shielding retains the stray field within certain prescribed limits and boundaries. Conventional magnetic resonance imaging systems with an active shielded magnet have two sets of superconducting coils, the first set of superconducting coils, referred to as the “main” coils, are positioned in the helium vessel relatively close to where a subject to be imaged is positioned during imaging. The second set of superconducting coils, referred to as the bucking coils, are positioned in the helium vessel on the outside from the main coils. A magnetic field of the bucking coil reduces the magnetic field of main coils outside of the magnet and retains the stray field within-certain prescribed limits and boundaries.

In regards to passive shielded magnets, the iron shielding is outside of the helium vessel and the iron shielding operates at room temperatures, approximately 21° C. The iron shielding is generally applied only to an MRI magnet system that has a low field (e.g. <=0.5 Teslas), because an MRI magnet with a higher field requires a very heavy iron shield. For an active shielded magnet, the position of bucking coils outside the main coils results in a rather high amount of magnetic coupling between the main coils and the bucking coils. The magnetic field of the bucking coils interferes with the magnetic field of the main coils in an imaging region and reduces the magnetic field generated by the main coils, which in turn requires main coils with a much larger size to produce a magnetic field with sufficient strength to induce sufficient resonance in a subject in order to image the subject. The larger main coils require additional expense to manufacture, additional expense to operate, and a larger magnet size. The larger magnet size is particularly inappropriate for small medical facilities that lack generous amounts of floor space in the facility. The larger size is also particularly inappropriate for imaging procedures of a small portion of a subject, such as in orthopedic imaging procedures, in which a large magnetic resonance imaging system is not needed.

For the reasons stated above, and for other reasons stated below which will become apparent to those skilled in the art upon reading and understanding the present specification, there is a need in the art for a magnetic resonance imaging system that has smaller main coils that are less expensive to manufacture. There is also a need for a magnetic resonance imaging system that has a smaller size that is more appropriate for smaller medical facilities and orthopedic imaging procedures.

### BRIEF DESCRIPTION OF THE INVENTION

The above-mentioned shortcomings, disadvantages and problems are addressed herein, which will be understood by reading and studying the following specification.

In one aspect, an apparatus to image a subject comprises main coils that are operable to create a magnetic field of view (FOV) of the subject, bucking coils that are operable to retain the magnetic FOV within a predefined range, and a ferromagnetic shield positioned between the main coils and the bucking coils. The ferromagnetic shield separates the magnetic flux between the main coils and the bucking coils, which in turn reduces the magnetic coupling between the main coils and the bucking coils. The reduced magnetic coupling requires smaller main coils and smaller bucking coils to generate a magnetic field of sufficient strength to image a subject while retaining the stray field within certain prescribed limits and boundaries. The smaller main coils and bucking coils of the apparatus are less expensive to manufacture because of the reduced material cost of the smaller main coils and bucking coils. In one embodiment, the ferromagnetic shield is an iron shield.

In another aspect, the main coil, ferromagnetic shield and bucking coils are enclosed in a cryostat, such as a liquid helium vessel.

In yet another aspect, the apparatus comprises further ferromagnetic shields positioned outside of the cryostat.

In still another aspect, the cryostat and further ferromagnetic shields are enclosed a vacuum vessel.

In a further aspect, the apparatus has a size and shape that is particularly well-suited to orthopedic medical imaging, such as an outside diameter of about 64 centimeters, an inside diameter of about 32.2 centimeters, and a length along a longitudinal axis of about 55 centimeters.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram that provides a system level overview of a magnetic resonance imaging (MRI) system with a ferromagnetic shield between main coils and bucking coils,

FIG. 2 is a block diagram of a MRI apparatus having an iron shield between main coils and bucking coils,

FIG. 3 is a block diagram of a MRI apparatus having a ferromagnetic shield in a helium vessel between main coils and bucking coils,

FIG. 4 is a block diagram of a MRI apparatus having an iron shield in a helium vessel between main coils and bucking coils, and

FIG. 5 is a flowchart of a method 500 for assembling a MRI system.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into five sections. In the first section, a system level overview is described. In the second section, apparatus of embodiments are described. In the third section, methods of embodiments are described. Finally, in the fourth section, a conclusion of the detailed description is provided.

### System Level Overview

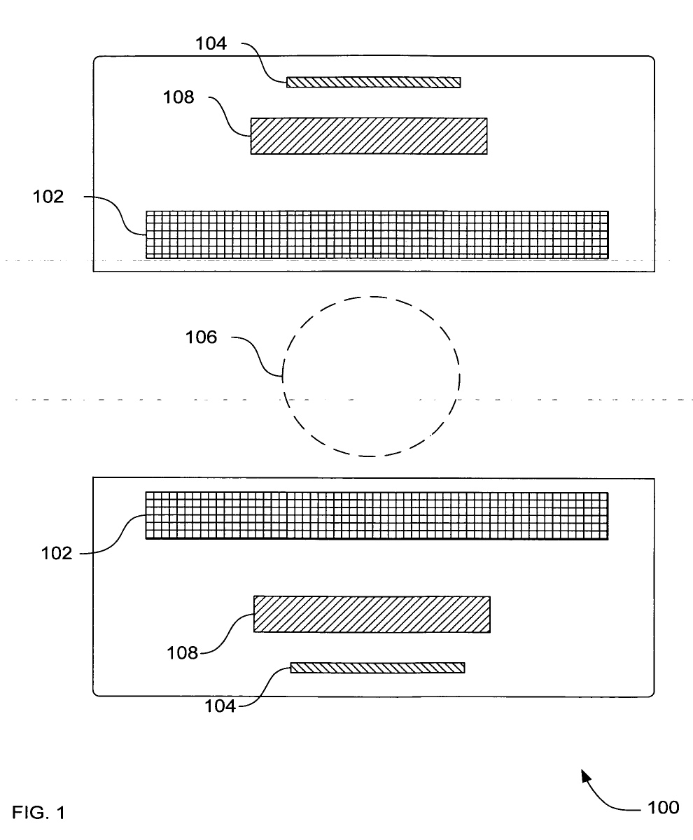

FIG. 1 is a block diagram that provides a system level overview of a magnetic resonance imaging (MRI) system with a ferromagnetic shield between main coils and bucking coils. System 100 solves the need in the art a MRI that has a smaller size that is more appropriate for smaller medical facilities and for use in orthopedic imaging procedures and that has smaller main coils and bucking coils that are less expensive to manufacture.

System 100 includes main coils 102 and bucking coils 104. The main coils 102 are operable to generate a magnetic field of view (FOV) 106 of the subject (not shown) such as a human or a portion of a human. The bucking coils 104 are operable to retain the magnetic FOV within a predefined range. The bucking coils are also known as shielding coils.

System 100 also includes a ferromagnetic shield 108. The ferromagnetic shield 108 is positioned between the main coils 102 and the bucking coils 104. The ferromagnetic shield 108 separates the magnetic flux between the main coils 102 and the bucking coils 104, which in turn reduces the magnetic coupling between the main coils 102 and the bucking coils 104. The reduced magnetic coupling requires smaller main coils 102 and bucking coil 104 to generate the magnetic FOV 106 of sufficient strength to image a subject. The smaller main coils 102 and bucking coil 104 of system 100 are less expensive to manufacture because the material cost of the smaller main coils 102 and smaller bucking coils 104 is less. Thus, the ferromagnetic shield 108 of system 100 fulfills the need in the art for a MRI system that has smaller main coils 102 and bucking coils 104 that are less expensive to manufacture.

The smaller main coils 102 and smaller bucking coils of system 100 also provide an MRI system that has an overall smaller size. Thus, the ferromagnetic shield 108 of system 100 fulfills the need in the art for a MRI system that has a smaller size that is more appropriate for smaller medical facilities and orthopedic imaging procedures.

The system level overview of the operation of an embodiment has been described in this section of the detailed description. While the system 100 is not limited to any particular main coils 102, bucking coils 104, FOV 106 and ferromagnetic shield 108, for sake of clarity a simplified main coils 102, bucking coils 104, FOV 106 and ferromagnetic shield 108 have been described.

### Apparatus of an Embodiment

In the previous section, a system level overview of the operation of an embodiment was described. In this section, the particular apparatus of such an embodiment are described by reference to a series of diagrams.

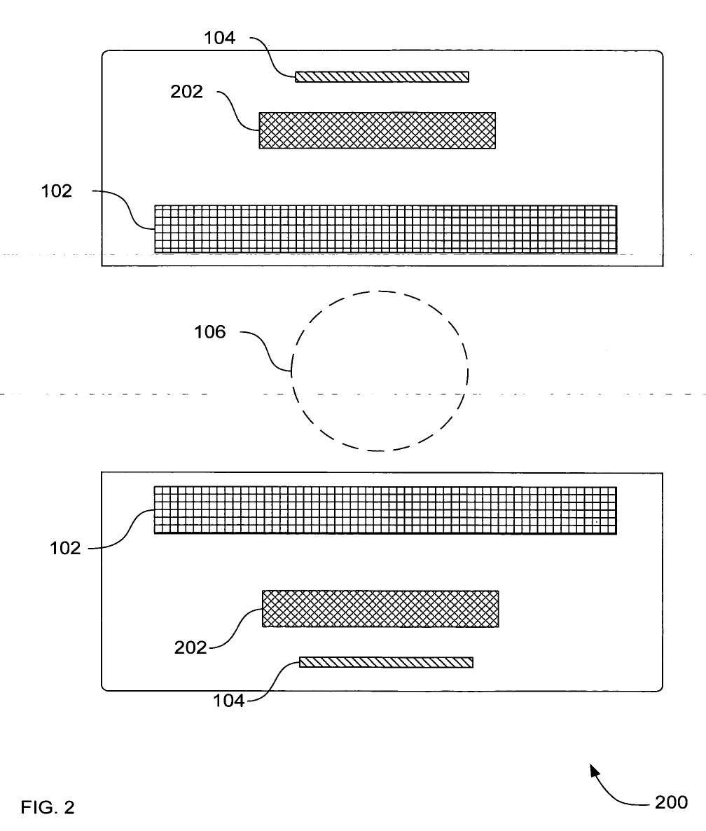

FIG. 2 is a block diagram of a magnetic resonance imaging (MRI) apparatus 200 having an iron shield between main coils and bucking coils. Apparatus 200 fulfills the need in the art for a MRI that has a smaller size that is more appropriate for smaller medical facilities and that is more appropriate for use in orthopedic imaging procedures, and that has smaller main coils and bucking coils that are less expensive to manufacture.

Apparatus 200 includes an iron shield 202 positioned between main coils 102 and bucking coils 104. The thickness of iron shield 202 depends on field strength and the geometry of main coils and bucking coils. In some embodiments, the thickness of the iron shield 202 is 3-5 centimeters.

The iron shield 202 separates the magnetic flux between the main coils 102 and the bucking coils 104, which in turn reduces the magnetic coupling between the main coils 102 and the bucking coils 104. The reduced magnetic coupling requires smaller main coils 102 and bucking coils 104 to generate the magnetic FOV 106 of sufficient strength to image a subject. The smaller main coils 102 and smaller bucking coils 104 of apparatus 200 are less expensive to manufacture because the material cost of the smaller main coils 102 and bucking coils is less. Thus, the iron shield 202 fulfills the need in the art for a MRI system that has smaller main coils 102 and bucking coils that are less expensive to manufacture. The smaller main coils 102- and smaller bucking coils of apparatus 200 provide an MRI system that has an overall smaller size. Thus, the iron shield 202 of apparatus 200 fulfills the need in the art for a MRI system that has a smaller size that is more appropriate for smaller medical facilities and orthopedic imaging procedures.

An iron shield embodiment has been described in this section of the detailed description. While the apparatus 200 is not limited to any particular iron shield 202, for sake of clarity a simplified iron shield 202 has been described.

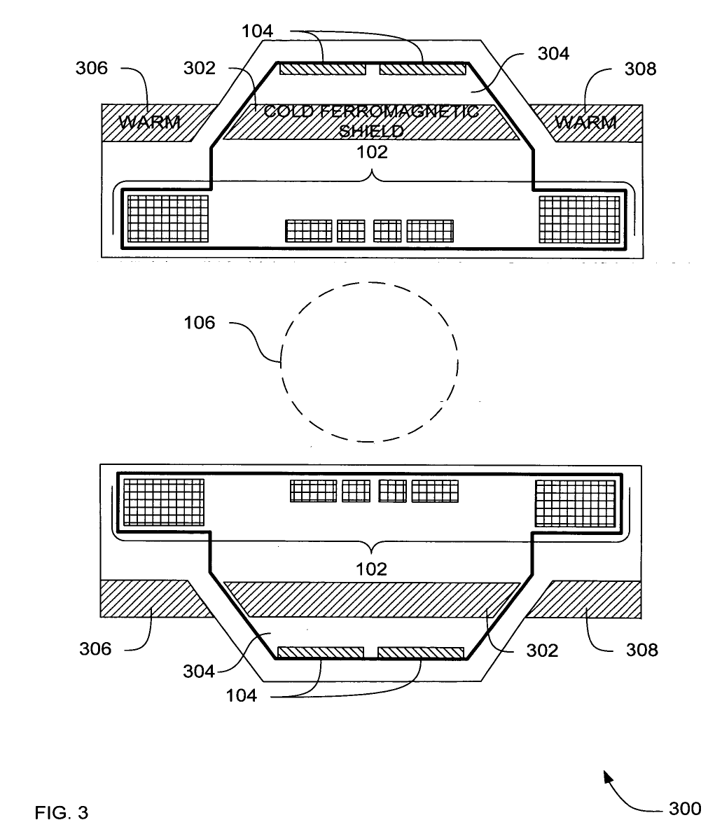

FIG. 3 is a block diagram of a MRI apparatus 300 having a ferromagnetic shield in a helium vessel between main coils and bucking coils. Apparatus 300 fulfills the need in the art for a MRI that has a smaller size that is more appropriate for smaller medical facilities and that is more appropriate for use in orthopedic imaging procedures, and that has smaller main coils and bucking coils that are less expensive to manufacture.

Apparatus 300 includes a ferromagnetic shield 302 positioned in a helium vessel 304 between main coils 102 and bucking coils 104. The ferromagnetic shield 302 is cooled by liquid helium (not shown) in the helium vessel 304, and therefore is described as a “cold ferromagnetic shield.” Thus, the cooled ferromagnetic shield 302 operates as a passive shield between the main coils 102 and the bucking coils 104, which in turn reduces the magnetic coupling between the main coils 102 and the bucking coils 104.

The reduced magnetic coupling between the main coils 102 and the bucking coils 104 requires smaller main coils 102 and smaller bucking coils 104 to generate the magnetic FOV 106 of sufficient strength to image a subject. The smaller main coils 102 and smaller bucking coils 104 of apparatus 300 are less expensive to manufacture because the material cost of the smaller main coils 102 and bucking coils 104 is reduced. Thus, the ferromagnetic shield 302 fulfills the need in the art for a MRI system that has smaller main coils 102 and smaller bucking coils 104 that are less expensive to manufacture. The smaller main coils 102 and smaller bucking coils 104 of apparatus 300 provide an MRI system that has an overall smaller size. Thus, the ferromagnetic shield 302 of apparatus 300 fulfills the need in the art for a MRI system that has a smaller size that is more appropriate for smaller medical facilities and orthopedic imaging procedures.

In some embodiments, apparatus 300 also includes ferromagnetic shielding 306 and 308 outside of the helium vessel 304. Ferromagnetic shielding 306 and 308 operate at the ambient temperature, such as “room temperature” approximately 21° C. and therefore are described as a “warm shield.” Thus, apparatus 300 includes three portions of ferromagnetic shielding, 302, 306 and 308. The three portions and the bucking coils outside of the cooled shield in helium vessel comprise a hybrid shield.

An embodiment having a ferromagnetic shielding 302 in a helium vessel 304 and ferromagnetic shielding 306 and 308 outside of the helium vessel has been described in this section of the detailed description. While the apparatus 300 is not limited to any particular ferromagnetic shield 302, 306 and 308 or helium vessel 304, for sake of clarity, simplified ferromagnetic shielding 302, 306 and 308 and or helium vessel 304 have been described.

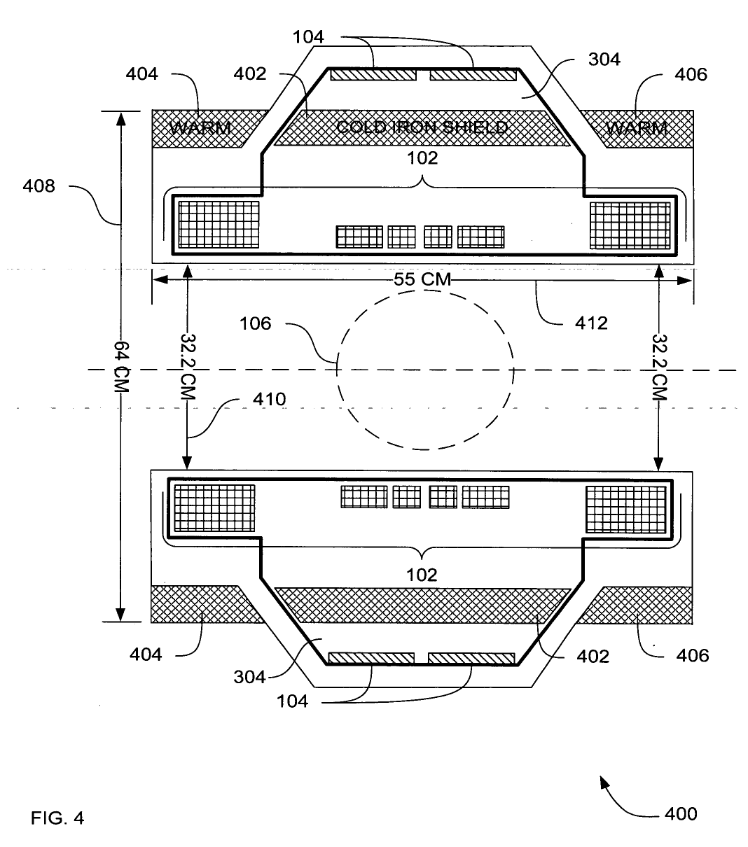

FIG. 4 is a block diagram of a MRI apparatus 400 having an iron shield in a helium vessel between main coils and bucking coils. Apparatus 400 satisfies the need in the art for a MRI apparatus that has a smaller size that is more appropriate for smaller medical facilities and orthopedic imaging procedures, and that has smaller main coils and smaller bucking coils that are less expensive to manufacture and operate.

Apparatus 400 includes an iron shield 402 positioned in a helium vessel 304 between main coils 102 and bucking coils 104. The iron shield 402 is cooled by liquid helium (not shown) in the helium vessel 304, and therefore operates as an active shield between the main coils 102 and the bucking coils 104, which in turn reduces the magnetic coupling between the main coils 102 and the bucking coils 104.

The reduced magnetic coupling between the main coils 102 and the bucking coils 104 requires smaller main coils 102 and smaller bucking coils 104 to generate a magnetic FOV 106 of a sufficient strength to image a subject. Thus, the less expensive smaller main coils 102 and smaller bucking coils of apparatus 400 fulfills the need in the art for a MRI apparatus that has smaller main coils 102 and bucking coils that are less expensive to manufacture. The smaller main coils 102 and smaller bucking coils 104 of apparatus 300 provide an MRI system that has an overall smaller size.

In some embodiments, apparatus 400 also includes iron shielding 404 and 406 outside of the helium vessel 304. Iron shielding 404 and 406 operate at the ambient temperature, such as “room temperature” approximately 21° C. and therefore are described as a “warm shield.” Thus, apparatus 400 includes three portions of iron shielding, 402, 404 and 406.

In orthopedic embodiments of apparatus 400 and apparatus 200, 300 and 400, an outside diameter 408 is about 64 centimeters. In addition, an inside diameter 410 is about 32.2 centimeters and a longitudinal axis 412 is about 55 centimeters.

In some embodiments of apparatus 400, the center magnetic field is 3 Teslas, the homogeneity of the FOV 106 is 7.5 ppm at 16 DSV, the radial and axial dimensions of the 5 Gauss line is 1.5 meters X 2.0 meters, the current to the main coils is 780A. In an environment of a high critical temperature (Tc) for superconducting of apparatus 400, the mail coils 102 and the bucking coils 104 are made of high Tc (HTc) superconductors, the cold vessel 304 comprises a single cryostat containing gaseous molecular nitrogen (N₂) for rapid cooling of magnet (main coils 102 and bucking coils 104), the magnet is operated at a temperature slightly above the temperature of liquid N₂ to unify the magnet temperature and/or apparatus 400 does not include a thermal shield.

An embodiment having iron shielding 402 in a helium vessel 304 and iron shielding 404 and 406 outside of the helium vessel has been described in this section of the detailed description. While the apparatus 400 is not limited to any particular iron shield 402, 404 and 406 or helium vessel 304, for sake of clarity, simplified iron shielding 402, 404 and 406 and or helium vessel 304 have been described.

### Methods of an Embodiment

In the previous section, apparatus of the operation of an embodiment was described. In this section, the particular methods performed in a manufacturing process of such an embodiment are described by reference to a series of flowcharts.

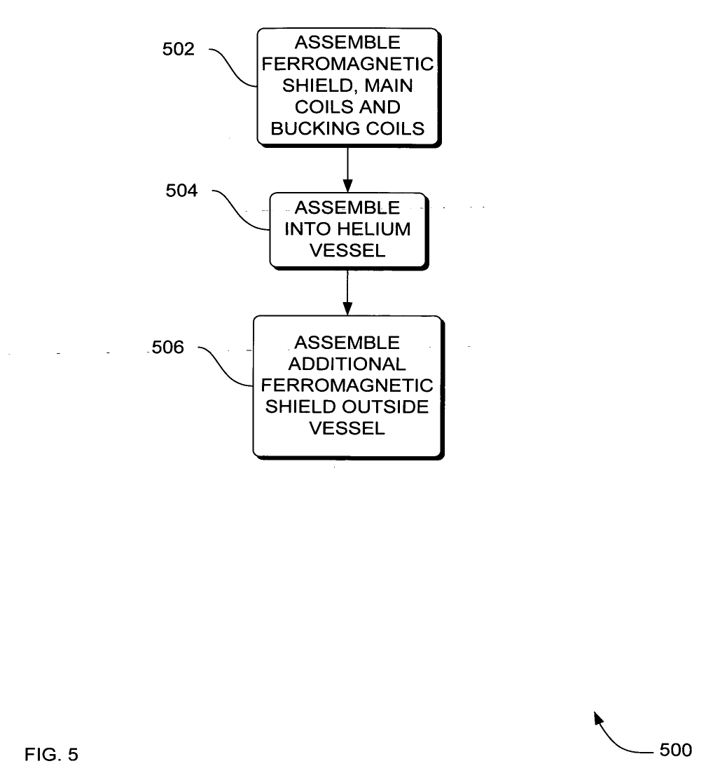

FIG. 5 is a flowchart of a method 500 for assembling a MRI system according to an embodiment. Method 500 allows a system and/or apparatus to be manufactured that satisfies the need in the art for a MRI that has a smaller size that is more appropriate for smaller medical facilities and orthopedic imaging procedures, and that has smaller main coils and smaller bucking coils that are less expensive to manufacture and operate.

Method 500 includes assembling 502 a first ferromagnetic shield with main magnetic coils and bucking magnetic coils. Examples of the first ferromagnetic shield include ferromagnetic shield 108 in FIG. 1 and ferromagnetic shield 302 in FIG. 3. Examples of the main coils and the bucking coils are main coils 102 and bucking coils 104 in FIGS. 1, 2, 3 and 4.

Thereafter, the assembled iron shield, main magnetic coils and bucking magnetic coils are assembled 504 into a helium vessel. In some embodiments, method 500 further includes assembling 506 one or more additional ferromagnetic shields outside the helium vessel. Examples of the additional ferromagnetic shields include ferromagnetic shielding 306 and 308 in FIG. 3 and iron shielding 404 and 406 in FIG. 4.

### CONCLUSION

A magnetic resonance imaging system (MRI) with a ferromagnetic shield positioned between the main coils and the bucking coils has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future MRI devices, different main coils, and new bucking coils.

The terminology used in this application with respect to MRI is meant to include all medical and industrial environments and alternate technologies which provide the same functionality as described herein

1. An apparatus to image a subject, the apparatus comprising:
main coils operable to create a magnetic field of view of the subject;
bucking coils to retain the magnetic field of view within a predefined range; and
a ferromagnetic shield positioned between the main coils and the bucking coils.

2. The apparatus of claim 1, wherein the ferromagnetic shield further comprises:
an iron shield.

3. The apparatus of claim 2, wherein the iron shield further comprises:
an iron shield having a thickness in a range of 3 to 5 centimeters.

4. The apparatus of claim 3, wherein the iron shield further comprises:
an iron shield having a thickness of about 4 centimeters.

5. The apparatus of claim 1, wherein the apparatus further comprises:
a helium vessel operable to contain liquid helium, the helium vessel further comprising the main coils, the bucking coils and the ferromagnetic shield.

6. The apparatus of claim 5, wherein the ferromagnetic shield is cooled by the liquid helium during operation.

7. An apparatus to image a subject, the apparatus comprising:
a cryostat comprising:
coils operable to create a magnetic field of view of the subject, and
bucking coils to retain the magnetic field of view within a predefined range; and
a ferromagnetic shield having a portion that is operable to be cooled by the cryostat and a portion that is not operable to be cooled by the cryostat.

8. The apparatus of claim 7, wherein the portion of the ferromagnetic shield that is operable to be cooled by the cryostat further comprises:
a portion of the ferromagnetic shield that is entirely internal to the cryostat.

9. The apparatus of claim 7, wherein the portion of the ferromagnetic shield that is not operable to be cooled by the cryostat further comprises:
a portion of the ferromagnetic shield that is entirely external to the cryostat.

10. The apparatus of claim 7, wherein the ferromagnetic shield further comprises:
an iron shield.

11. The apparatus of claim 10, wherein the iron shield further comprises:
an iron shield having a thickness in a range of 3 to 5 centimeters.

12. The apparatus of claim 11, wherein the iron shield further comprises:
an iron shield having a thickness of about 4 centimeters.

13. A magnetic resonance imaging system comprising:
a helium cryostat vessel comprising:
main coils operable to create a magnetic field of view of the subject;
bucking coils to retain the magnetic field of view within a predefined range; and
a ferromagnetic shield having a first portion positioned between the main coils and the bucking coils, and a plurality of further portions positioned not between the main coils and the bucking coils.

14. The apparatus of claim 13, wherein the ferromagnetic shield further comprises:
an iron shield.

15. The apparatus of claim 14, wherein the iron shield further comprises:
an iron shield having a thickness of about 3.5 centimeters.

16. The apparatus of claim 13, wherein the apparatus further comprises:
a helium vessel operable to contain liquid helium, the helium vessel further comprising the main coils, the bucking coils and the first portion of the ferromagnetic shield.

17. The apparatus of claim 13, wherein the apparatus further comprises:
an outside diameter of about 64 centimeters;
an inside diameter of about 32.2 centimeters; and
a length along a longitudinal axis of about 55 centimeters.

18. The apparatus of claim 16, wherein the first portion of the ferromagnetic shield is cooled by the liquid helium during operation.

19. An orthopedic magnetic resonance imaging system comprising:
a vacuum vessel comprising:
a cryostat helium vessel operable to contain liquid helium, the cryostat helium vessel comprising:
main coils operable to create a magnetic field of view of a subject;
bucking coils to retain the magnetic field of view within a predefined range; and
an iron shield positioned between the main coils and the bucking coils, the iron shield having a thickness of about 3.5 centimeters,
a plurality of iron shields positioned outside of the helium cryostat vessel and positioned within the vacuum vessel,
wherein the orthopedic magnetic resonance imaging system further comprises:
an outside diameter of about 64 centimeters;
an inside diameter of about 32.2 centimeters; and
a length along a longitudinal axis of about 55 centimeters.

20. (canceled)

21. (canceled)

22. The orthopedic magnetic resonance imaging system of claim 19, wherein the plurality of iron shields positioned outside of the helium cryostat vessel and positioned within the vacuum vessel further comprise an ambient temperature.
